(19) United States
(12) Patent Application Publication
(10) Pub. No.: US 2024/0135122 A1
(43) Pub. Date: Apr. 25, 2024

(54) METHOD AND SYSTEM FOR PATRON ID PROCESSING IN A CASINO ENVIRONMENT

(71) Applicant: Everi Payments Inc., Austin, TX (US)

(72) Inventors: Adam Fong, Las Vegas, NV (US); Steve Nguyen, Santa Ana, CA (US); Justin Nelson, Las Vegas, NV (US); Naveen Prabhaker, Las Vegas, NV (US); Shan Veerappan, Las Vegas, NV (US)

(21) Appl. No.: 18/376,941

(22) Filed: Oct. 4, 2023

Related U.S. Application Data
(60) Provisional application No. 63/414,292, filed on Oct. 7, 2022.

(51) Int. Cl. G06K 7/12; G06K 7/14; G07F 17/32

(52) U.S. Cl. CPC G06K 7/12; G06K 7/1404; G07F 17/3234; G07F 17/3239

(57) ABSTRACT

A method and system for patron ID processing in a casino environment may present ID authentication results via graphical user interface which includes primary and secondary results indicators, and may be distributed to allow users of multiple workstations to scan patron IDs via a common scanner and access the scanned ID information from a pool, where scanned ID information is protected by being deleted when selected or if not selected in a period of time. The scanned ID information may be used in an ID authentication process, including where that process may run in the background of another application.

### RELATED APPLICATION DATA

This application claims priority to U.S. Provisional Patent Application Ser. No. 63/414,292, filed Oct. 7, 2022, which prior application is incorporated by reference in its entirety herein.

### FIELD OF THE INVENTION

The present invention relates to patron identification processing in a casino environment, such as in association with casino monetary transactions.

### BACKGROUND OF THE INVENTION

Casinos frequently need to validate the identity of a player or patron. For example, a casino might desire to validate the identity of a player when the player seeks to enroll in the casino's player loyalty program. A casino might also desire to validate the player's identity in association with a financial transaction, such as the payment of a jackpot or when providing a player with funds, such as via a marker or by cashing a check, or for other reasons, such to comply with jurisdictional rules as implemented by internal controls.

Existing methods and systems associated with such validation have numerous drawbacks. One problem is that a casino might need to validate a player's identity at a large number of locations, such as at a large number of cage or attendant stations. This generally requires each station to include the necessary hardware and software for this task, such as including a dedicated ID scanner which is used to scan the player's ID, or multiple scanners, such as to support the scanning of different types of IDs (such as those of different sizes, such as driver's licenses vs. passports).

Another problem that exists with ID processing relates to providing the results of validation of the ID. Existing methods often make it difficult for a user to identify or interpret the validation results, which can lead to errors (including approvals of transactions that should be refused, etc.).

### SUMMARY OF THE INVENTION

Embodiments of the invention comprise methods and systems for patron ID processing in a casino environment.

In one embodiment of the invention, the results of the processing of a patron's ID is indicated by a graphical user interface, the graphical user interface comprising at least a first primary results indicator and a second results indicator. The primary results indicator may comprise a textual indicator, such as PASS or FAIL, and the secondary results indicator may comprise a non-textual indicator, such as a color (red, green, yellow, etc.), a symbol or the like.

In one embodiment, patron ID processing is distributed, such as where users of multiple workstations scan patron IDs via a common ID scanner and access the scanned ID information from a scan pool, thus reducing the number of needed scanners. The scanned ID information may be protected by being deleted when selected by a workstation user or being deleted if not selected in a period of time.

The scanned ID information may be used in an ID authentication process, including where that process may run in the background of another application. A pop-up window may display the result of the authentication process to the user in another application.

In some embodiment, ID authentication may be implemented via a mobile device, such as using an application running on the mobile device.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system of the present invention;

FIGS. 2A-K illustrate exemplary interfaces which may be displayed via a user device in accordance with a first embodiment of the invention; and

FIGS. 3A-G illustrate exemplary interfaces which may be displayed via a user device in accordance with a second embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods and systems for distributed patron ID processing in a casino environment.

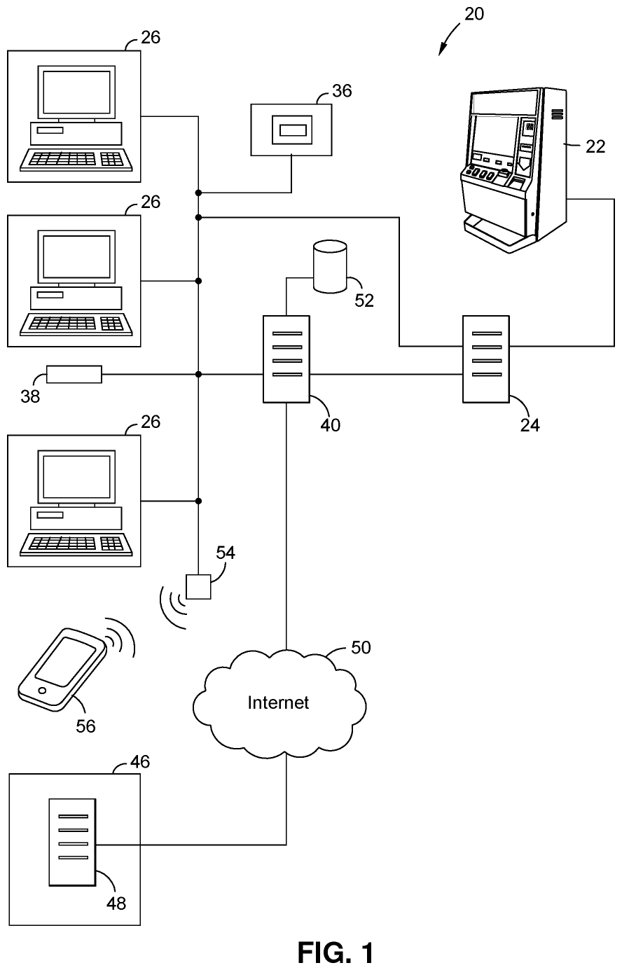

One embodiment of a system 20 of the invention is illustrated in FIG. 1. In one embodiment, the system 20 comprises, includes, or is communicatively linked to, a casino environment. As such, the system 20 may include a plurality of gaming devices, such as one or more gaming machines 22. The system 20 may include other types of gaming devices such as gaming tables and the like, as which one or more games, and preferably wager-based games which offer a player the opportunity for winnings, are presented.

The system 20 may include one or more casino servers 24 (or similar computing devices). The casino servers 24 may comprise one or more processors or controllers, at least one communication device or interface, a database or other data storage device, and one or more additional memory or data storage devices (such as separate from the database). In one or more embodiments, the processor(s) is configured to execute one or more instructions, such as in the form of machine readable code (i.e. “software”), to allow the server 24 to perform various functionality, such as the functionality described herein. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the casino server 24 may include (or be linked communicatively at one or more times to) one or more input and/or output devices, such as a keyboard, mouse, touchscreen, video display or the like, whereby the processor may receive information from an operator or servicer of the server 24 and/or output information thereto. This allows, for example, an operator of the server 24 to interface with the server 24 to upgrade, maintain, monitor, etc., it. In other embodiments, an operator might interface with the server 24 via a separate workstation or other device.

In one embodiment, the processor and other elements of the server 24 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server 24 to communicate with the gaming machines 22 or other gaming devices, and preferably external devices, networks, systems and the like.

The casino server 24 may be configured to implement a variety of functionality (and/or there may be a plurality of different servers which each implement different functionality). In one embodiment, the server 24 may implement accounting functionality. The accounting functionality might include tracking of wagers made and winnings paid at the gaming machines 22 and, as described in more detail below, tracking monetary transactions at a cashier cage, such as tracking the amounts of casino chips issued and redeemed, checks cashed, etc. In the case of a gaming system which includes the issuance of monetary value tickets or the like, the server 24 may also generate monetary value ticket data, validate tickets and the like.

The cashier cage of the system 20 may include a plurality of cashier workstations 26, at least one monetary value dispensing mechanism 36, and at least one ID reader 38. The cashier workstations 26 may comprise, for example, a computing type device which comprises a processor, a memory, software stored in the memory for execution by the processor, one or more cashier input devices (such as a keyboard or keypad, mouse, etc.), a communication interface and at least one video display.

In one embodiment, a plurality of cashier workstations 26 are configured to communicate with a single ID reader 38 (e.g., a dedicated ID reader 38 is not provided for each cashier workstation 26). The ID reader 38 may comprise a wide variety of reading devices, such as one or more of a white light, IR and UV light scanner or reader, a magnetic stripe reader or the like. The reader 38 might be particularly configured to scan or read information associated with an ID, such as a state driver's license, passport or the like.

In one embodiment, each cashier workstation 26 may be configured to communicate with the monetary value dispensing mechanism 36, either directly or indirectly (such as through a cash system server, as detailed below). This mechanism 36 preferably comprise a secure monetary value storage and dispensing mechanism. The mechanism 36 may be configured to store or house monetary value, such as paper currency and/or coins and, at one or more times, dispense monetary value to the cashier. One such device is sold under the name CageConnect™ by Everi Payments Inc. of Las Vegas, NV.

As illustrated, the system 20 may include or communicate with other systems or features, such as a customer or player identification, loyalty and tracking system (a “customer” system). The customer system may comprise a customer server, such as a computing device with a processor, a memory, data storage, communication interface and the like, machine-readable code for execution by the processor. The system may be configured to identify customers, gain and maintain customer interest in game play, and share data regarding customers. For example, the customer system may collect information from the gaming machines 22 regarding player game play and reward players for that play, such as by awarding promotional award to them. The player loyalty system might, for example, be implemented by the one or more casino servers 24.

The system 20 may further comprise a processing system 40. This system 40 may be configured to aid in the processing of monetary transactions at the casino, such as via the cashier workstations 26. In one embodiment, the processing system 40 comprises one or more servers. Each of those servers may be similar to the casino server(s) 24 noted above (such as including a processor, memory, communication interface, etc.) but include software for implementing the functionality described herein. The processing system 40 might be operated by a vendor of the casino or might be part of the casino system itself.

In one embodiment, the processing system 40 may implement, or be communicate with, an anti-money laundering (AML) System. Such a system may comprise a floor monitor system that allows floor staff to view real-time information from devices in the casino, including information regarding transactions performed at those devices (such as gaming machines 22, cashier workstations 26, kiosks and other devices), such as in the form of a digital money transaction log (MTL) and a non-monetary instrument log (NIL) that support transaction entry, unknown patron handling, quick alerts, and more. The AML system may also include a back office system that enables a compliance team to review floor data, generate currency transactions reports (CTR) and/or suspicious activity reports (SAR) batches, and electronically file with regulators, providing a full audit log and flexible reporting of data. The AML system may further comprise a connector library system that allows importation of transactional data from casino management systems without manual entry, and/or a tax forms system for completing and managing tax forms required by the IRS or other governmental agencies.

As illustrated in FIG. 1, the system 20 may be configured to communicate with other systems and elements. For example, as illustrated, the processing system 40 is preferably configured to communicate with one or more authentication systems 46, such as an authentication system server 48 thereof. The communications may occur via the Internet 50 and/or other communication networks (wireless and/or wired, LANs, WANs, etc.). The authentication system 46 might comprise, for example, the FinScan® system operated by Innovative Systems, or the VeriDocs® system operated by VeriDocs, Inc.

The server of the processing system 40 might also communicate with other devices or systems. Such systems might comprise a banking system, such as for clearing or processing checks (such as for clearing a check presented by a casino customer by transferring funds from the customer's bank account to an account of the casino).

As described above, one aspect of the invention is a system in which one or more workstations or similar devices, such as cashier workstations 26, commonly communicate with and/or utilize, a common ID reader 38. An aspect of this feature of the invention is that it reduces the number of ID readers 38 which the casino needs in order to perform ID validation.

In general, in accordance with one aspect of the invention, multiple users may scan patron IDs using the common ID reader 38. The scanned information may be placed into a “scan pool.” This pool effectively comprises a temporary repository of scanned ID information for use by all of the linked devices, such as cashier workstations 26. As detailed below, different users may then access the scanned ID information from the pool, such as to complete a transaction. As further described below, in one embodiment, scanned ID information which is associated with the pool is removed from the pool when it is either claimed by an authorized user, or if it is not properly claimed in a designated period of time. As detailed, this removal aids in protecting the scanned ID information from unauthorized use or access.

In one embodiment, each cashier workstation 26 preferably includes machine-readable code (e.g., software or an “application”) which, when executed by the processor of the workstation 26, facilitates the implementation of the features herein. Other machine-readable code may be associated with the processing system 40, such as a server thereof. In one embodiment, a memory of the ID reader 38 may temporarily store information associated with the pool, or one or more other elements of the system may maintain the pool, such as the processing system 40 and an associated memory 52 thereof, whereby the pool is essentially maintained in a network buffer for shared access by multiple elements of the system. Further, in some embodiments, the workstations 52 might comprise thin clients which essentially simply act as display devices for remotely generated information, such as information generated by the processing system 40.

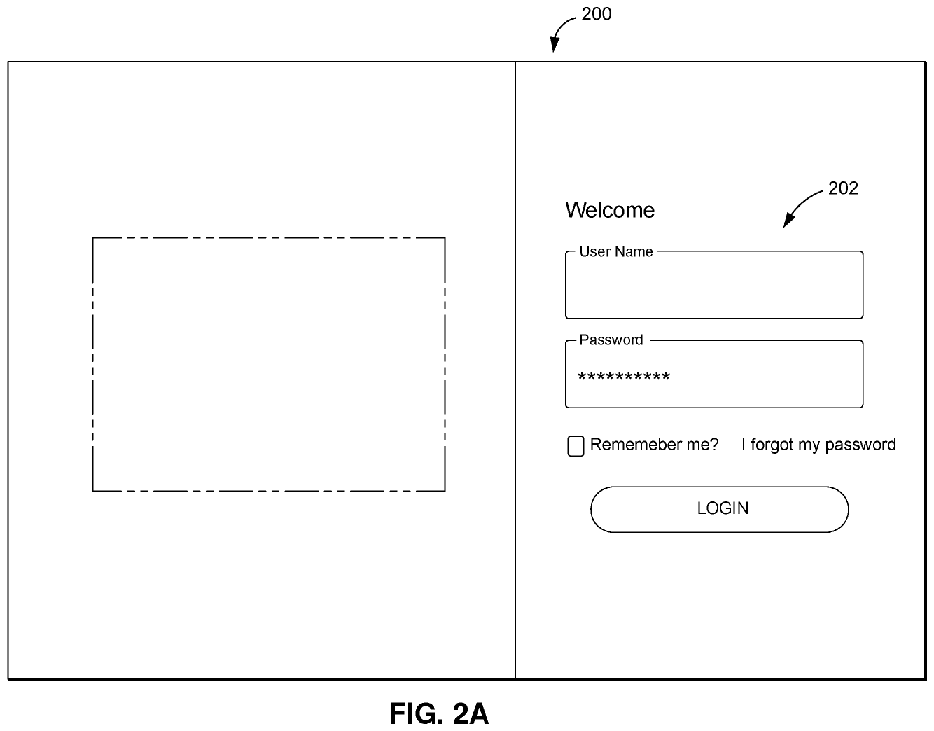

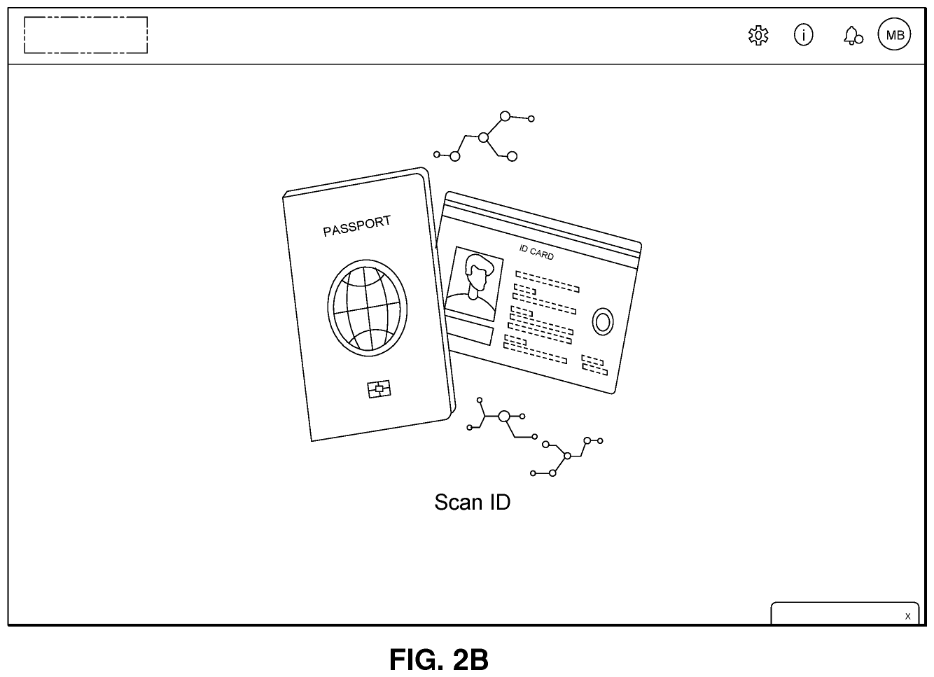

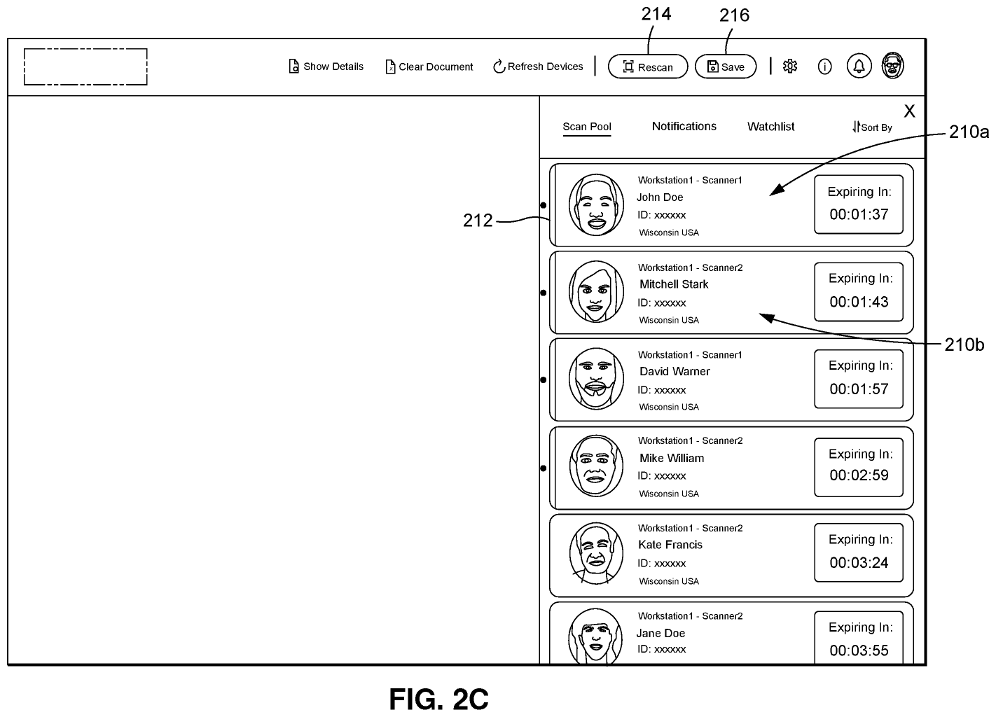

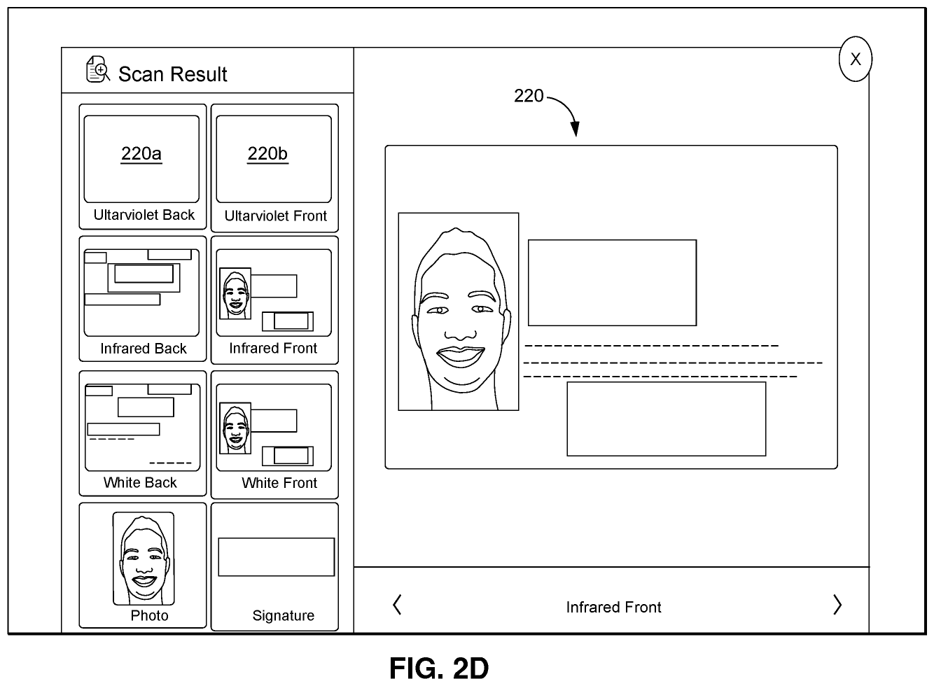

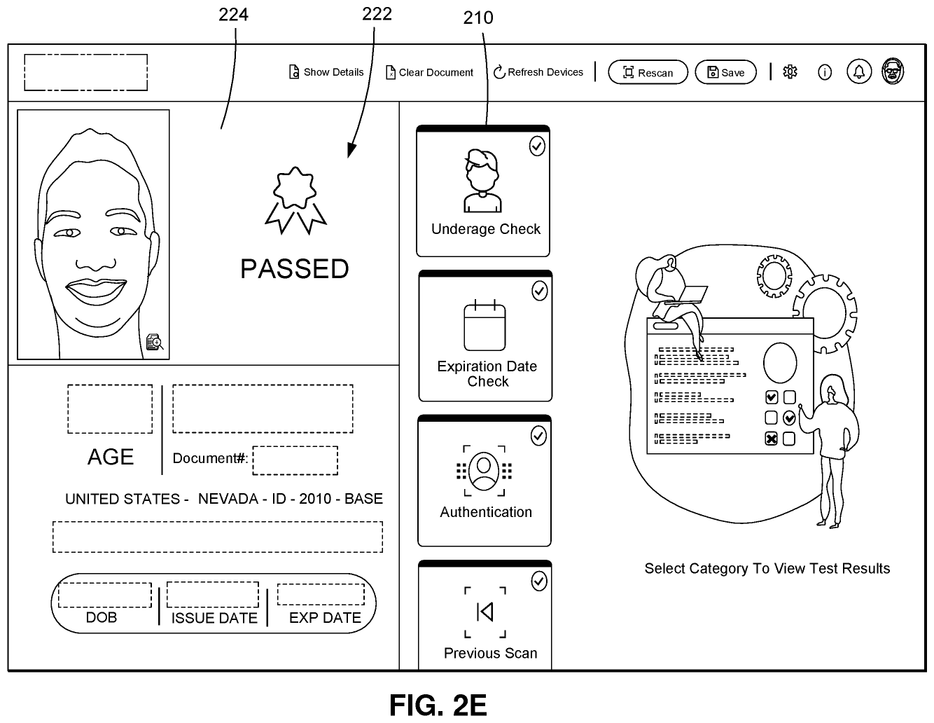

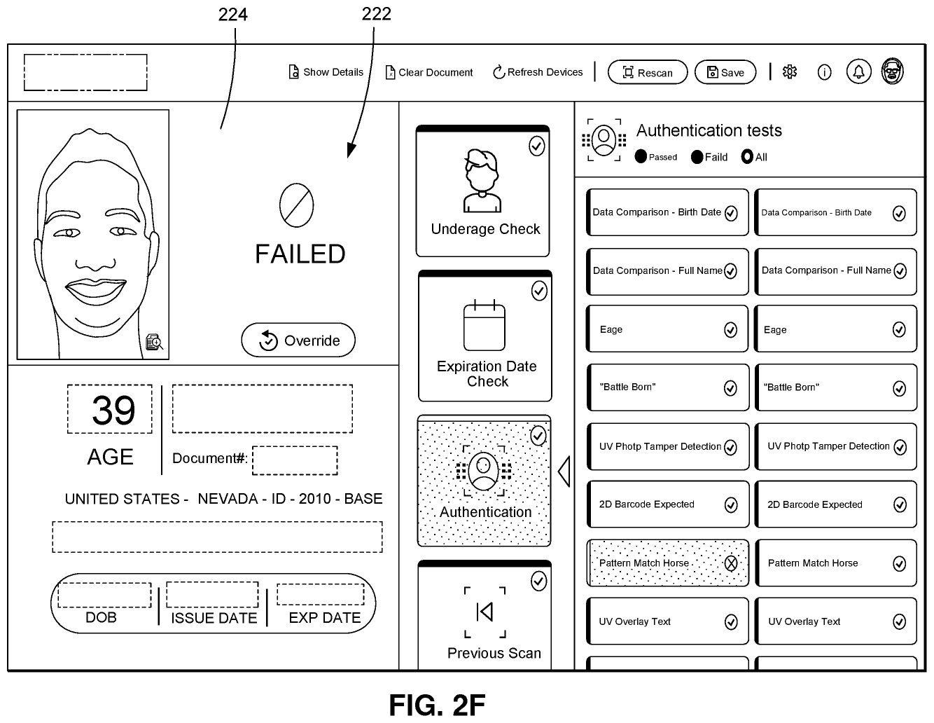

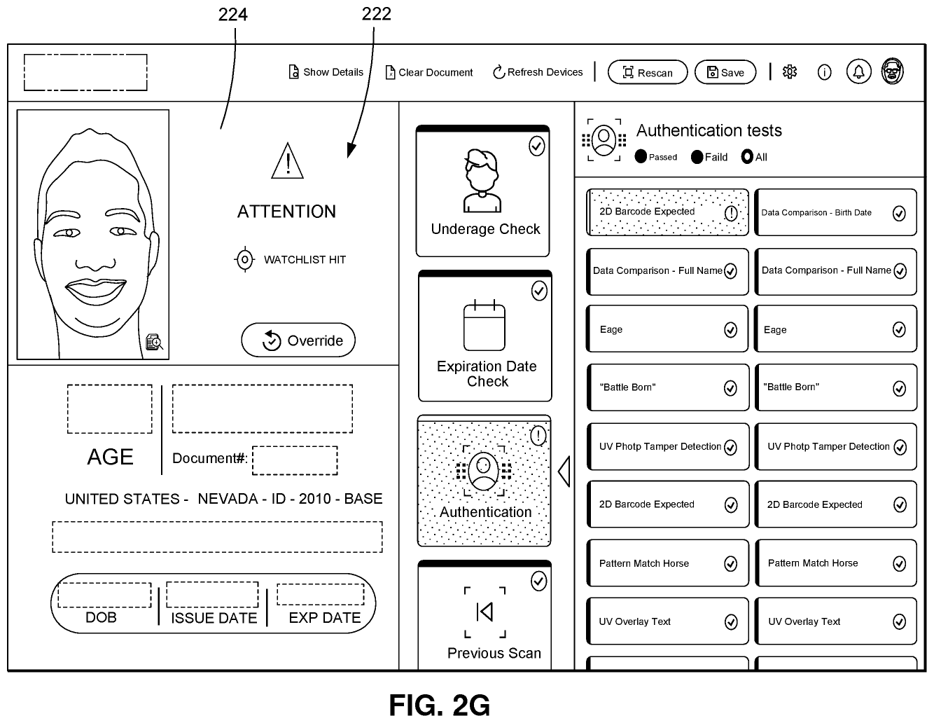

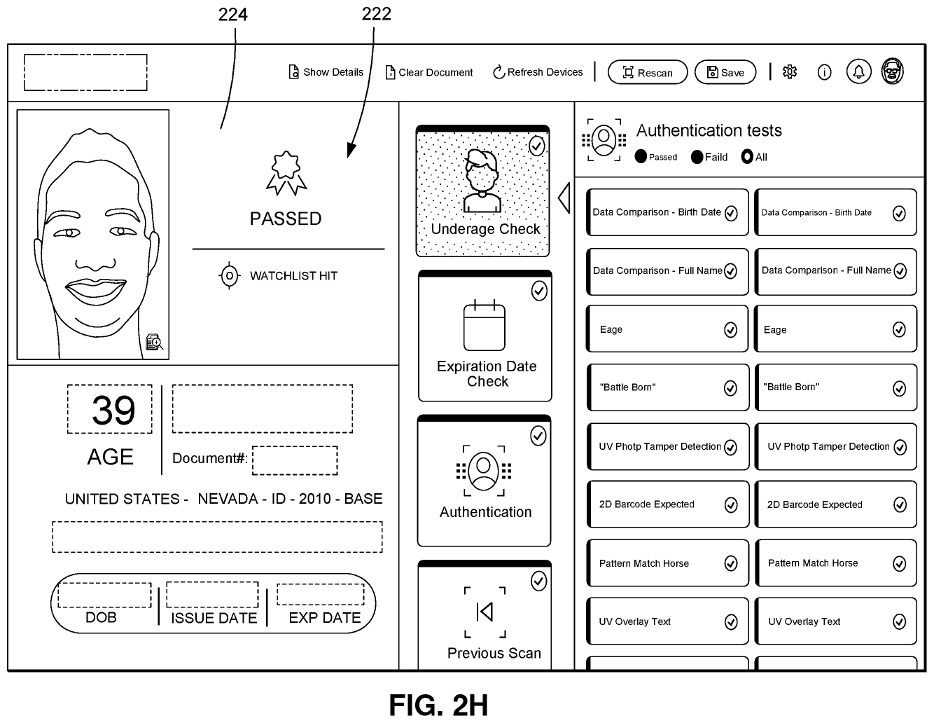

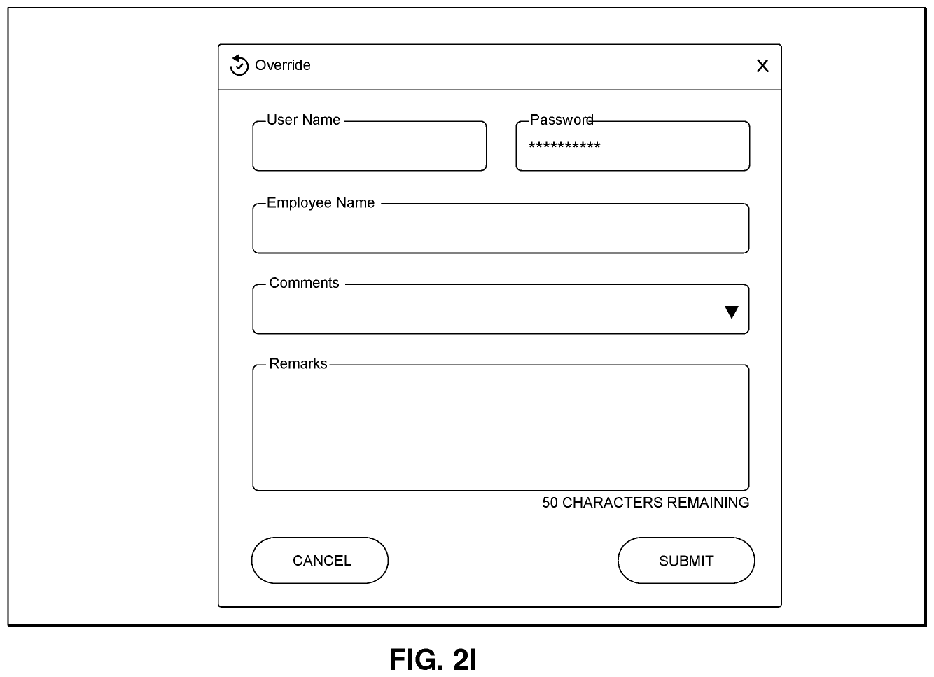

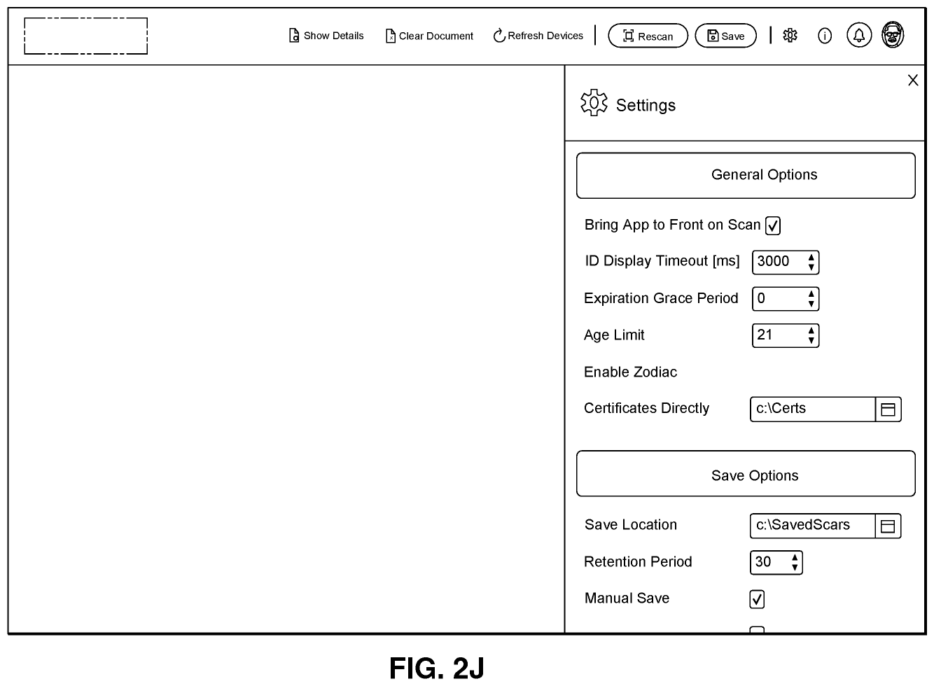

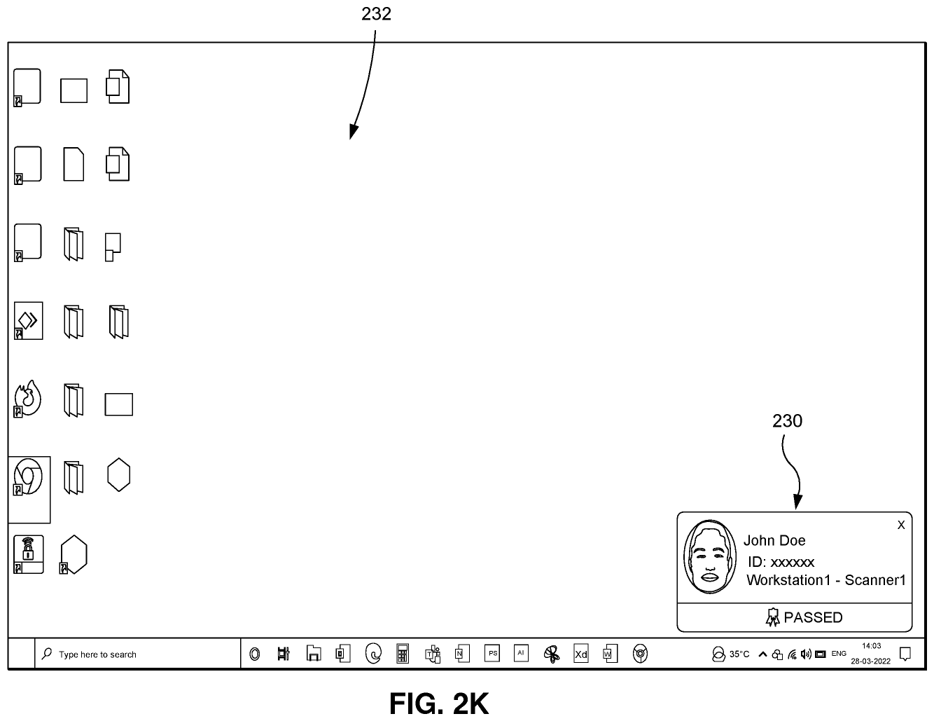

Additional aspects of the invention will be described with reference to FIGS. 2A-K, are examples of graphical user interfaces or other displays which may be displayed by a display of the casher workstation 26 during use thereof.

As illustrated in FIG. 2A, execution of an application in accordance with the invention may cause the display of a login page or interface 200 which requires entry of login information 202, such as a user name and password. Upon login, the functionality of the application may be implemented, including allowing the user to access scanned ID information from a scan pool (e.g., whereby only authorized users have access to the information in the scanned ID pool).

In one embodiment, each user may be assigned to a group and each group may have permission to access certain ID readers 38, and the scanned data associated therewith. This functionality may be implemented by assigning each workstation 26 to a scanning engine (such as implemented by software associated with the ID reader 38 and/or the workstation 26) which implements the permissions. As one example, users of cashier workstations 26 may be associated with a “cashier” group which has access to two ID readers 38 and the scanned ID information associated therewith. However, users of a compliance group may not have permission relative to those ID readers, and may thus not be permitted to access the scanned ID information associated therewith.

As illustrated in FIG. 2B, the user may be provided with the option to scan a patron's ID. This preferably involves the user obtaining the ID from the patron and reading it via the shared ID reader 38. As indicated above, this process may include obtaining different images of the ID. In one configuration, the scanned ID information is preferably provided to a scanned ID pool. As illustrated in FIG. 2C, the user may view the scanned ID pool to locate the scanned ID information for that patron. As described below, a graphically displayed box or other element 210a, 210b may be displayed relative to each scanned ID, which box or element may display associated information to aid the user in identifying the relevant ID scan (such as the image of the patron as scanned from the ID, the ID number, etc.). The user may “claim” particular scanned ID information, such as by selecting it from the pool.

As illustrated in FIG. 2C, various interfaces may be displayed to provide information regarding the contents of the scan pool and to aid the users of the workstations 26 to select the desired scanned ID information. It is noted that certain of these features might be selectively available, such as based upon the circumstances (for example, the displayed “RESCAN” 214 and “SAVE” 216 features might only be presented or be selectable when scanning an ID for authentication, but not when simply scanning the machine-readable portions of an ID for associated information (such as when reading a machine code associated with the ID to simply decode and present that information).

As indicated herein, in a preferred embodiment, once the ID scanned ID information is provided, it is removed or deleted from the pool (such as the network buffer) and may be provided to the workstation 26. As also described above, if scanned ID information is not claimed by a user of one of the linked workstations in a predetermined period of time, such as a few minutes, the scanned ID information may also be deleted from the scan pool.

FIG. 2D illustrates one example of scanned ID information. As illustrated, the scanned ID information may comprise different scans of the ID 220a, 220b, etc. (such as to obtain a white light image of the front and back of the ID, a UV light image of the front and back of the ID, an IR light image of the front and back of the ID) and parsing of information associated with the ID, such as the ID photo, signature, text (such as by using optical character recognition) and barcode, etc. The user may select one of the scans, such as display an enlarged view 220 thereof, such as in an adjacent portion of the interface.

Upon such a selection by the user, the scanned ID information may be analyzed, such as to determine its authenticity. As indicated above, such may comprise sending the scanned ID information to an outside vendor for authentication, such as via the processing system 40. It will be appreciated that various types of authentication may be performed relative to the scanned ID information in order to authenticate the ID, as is well known (and in some embodiments, initial analysis of the ID information may be performed by an outside vendor, but secondary or additional analysis may be performed by the processing system 40—for example, such as where the ID information is first checked to determine if is valid, such as by an outside vendor, and where the patron's ID information is then used in a second internal check, such as to determine if the patron is on a watch list, the ID or patron was previously flagged during a prior ID authentication, or otherwise complies with other criteria/checks).

Once the scanned ID information has been analyzed, a result is preferably provided to the user. In one embodiment, information obtained from the ID scan analysis and/or secondary information, it used to indicate the result. In a preferred embodiment, the result is indicated by one or more outcome indicators, and preferably two or more outcome indicators. One of the indicators may comprise a primary textual indicator, such as “PASS”, “ATTENTION” or “FAIL”. In addition, however, at least one secondary indicator, preferably comprising a non-textual indicator, such as colors or symbols, is utilized. For example, the color green may be applied to passing results, yellow to results which require attention, yellow with red text to results which require high attention, and red to failing results. Of course other indicators might be utilized, such as symbols (e.g. a thumbs-up or thumbs-down symbol, smiley face symbol or frowning symbol, the colors may be applied to backgrounds or other areas, to text or other elements, etc.).

Examples of combinations of analysis factors that may be considered, and their relationship to different scan results indicators are provided below in Tables 1 and 2.

TABLE 1

| PASS | FAIL | ATTENTION | ATTENTION |
|---|---|---|---|
| Green (recommended | Red (recommended to | Yellow (recommended to | Yellow with RED text (highly |
| to proceed) | not proceed) | review) | recommended to review) |
| Combinations | Combinations | Combinations | Combinations |
| ID Valid = | ID Valid = | ID Valid = | Warning = multiple mis-match |
| ID/DL/Passport/Passport | ID/DL/Passport/Passport | ID/DL/Passport/Passport | |
| Card meets agency format | Card meets format | Card meets format | |
| criteria between front | criteria between front | criteria between front | |
| OCR and back | OCR and back barcode | OCR and back barcode | |
| barcode comparison | comparison, but age | comparison, but age | |
| | limit is restricted in this | limit is restricted in this | |
| | area or approved use | area or approved use | |
| Current ID = | ID Invalid = | Current ID = | Current ID = |
| ID/DL/Passport/Passport | ID/DL/Passport/Passport | ID/DL/Passport/Passport | ID/DL/Passport/Passport Card |
| Card Issue Date | Card does not meet | Card Issue Date is within | Issue Date is within parameter |
| and Expiration Date | format criteria between | parameter range, but not | range, but not acceptable for |
| are within parameters | front OCR and back | acceptable for this area or | this area or approved use |
| | barcode comparison, | approved use | |
| | but age limit is | | |
| | restricted in this area or | | |
| | approved use | | |
| Valid Age = | Current ID = | Valid Age = Meets | Previous Scan = There have |
| Configurable to be | ID/DL/Passport/Passport | configured age | been multiple recent scans |
| valid age of 18 | Card Issue Date is | requirement (i.e. 18/21) | within configured timeframe |
| and/or 21 | within parameter range, | | across the casino floor |
| | but not acceptable for | | |
| | this area or approved | | |
| | use | | |
| | Underage = Does not | Watchlist Hit = Does not | |
| | meet configured age | meet configured | |
| | requirement (i.e. 18/21) | acceptable | |
| | | PEP/Sanctions/Banned- | |
| | | Barred/OFAC/TinCheck/ | |
| | | custom List | |
| | Valid Age = Meets | Previous Scan = There | |
| | configured age | have been multiple recent | |
| | requirement (i.e. 18/21) | scans within configured | |
| | | timeframe across the | |
| | | casino floor | |
| | Expired ID = | | |
| | ID/DL/Passport/Passport | | |
| | Card Expiration Date | | |
| | is out of parameter | | |
| | range | | |
| | Watchlist Hit = Does | | |
| | not meet configured | | |
| | acceptable | | |
| | PEP/Sanctions/Banned- | | |
| | Barred/OFAC/TinCheck/ | | |
| | custom List | | |
| | Previous Scan = There | | |
| | have been multiple | | |
| | recent scans within | | |
| | configured timeframe | | |
| | across the casino floor | | |
| | A restricted ID has been | | |
| | Scanned = Government | | |
| | Issued ID/Military ID | | |
| | has been scanned, but | | |
| | image cannot be | | |
| | copied/shown per legal | | |
| | restrictions. | | |

TABLE 2

| | Status/ | | | | | Previous | |
|---|---|---|---|---|---|---|---|
| Scenario | Color | Failure Reasons | | | Watchlist | Scan Alert | Action |
| 1 | ID Valid | N/A | | | | | All good to |
| | Green | | | | | | proceed |
| 2 | ID Valid | | | | Watchlist | | Recommended |
| | Yellow | | | | Hit | | to review |
| 3 | ID Valid | | | | | Previous | Proceed with |
| | Green | | | | | Scan Alert | caution |
| 4 | ID Valid | | | | Watchlist | Previous | Recommended |
| | Yellow | | | | Hit | Scan Alert | to review |
| 5 | ID Valid | Underage | | | | | Recommended |
| | Red | | | | | | not to proceed |
| 6 | ID Valid | Underage | | | Watchlist | | Recommended |
| | Red | | | | Hit | | not to proceed |
| 7 | ID Valid | Underage | | | | Previous | Recommended |
| | Red | | | | | Scan Alert | not to proceed |
| 8 | ID Valid | Underage | | | Watchlist | Previous | Recommended |
| | Red | | | | Hit | Scan Alert | not to proceed |
| 9 | ID Valid | Expired | | | | | Recommended |
| | Red | | | | | | not to proceed |
| 10 | ID Valid | Expired | | | Watchlist | | Recommended |
| | Red | | | | Hit | | not to proceed |
| 11 | ID Valid | Expired | | | | Previous | Recommended |
| | Red | | | | | Scan Alert | not to proceed |
| 12 | ID Valid | Expired | | | Watchlist | Previous | Recommended |
| | Red | | | | Hit | Scan Alert | not to proceed |
| 13 | ID Invalid | Authentication | | | | | Recommended |
| | Red | Failure | | | | | not to proceed |
| 14 | ID Invalid | Authentication | | | Watchlist | | Recommended |
| | Red | Failure | | | Hit | | not to proceed |
| 15 | ID Invalid | Authentication | | | | Previous | Recommended |
| | Red | Failure | | | | Scan Alert | not to proceed |
| 16 | ID Invalid | Authentication | | | Watchlist | Previous | Recommended |
| | Red | Failure | | | Hit | Scan Alert | not to proceed |
| 17 | ID Valid | Underage | Expired | | | | Recommended |
| | Red | | | | | | not to proceed |
| 18 | ID Valid | Underage | Expired | | Watchlist | | Recommended |
| | Red | | | | Hit | | not to proceed |
| 19 | ID Valid | Underage | Expired | | | Previous | Recommended |
| | Red | | | | | Scan Alert | not to proceed |
| 20 | ID Valid | Underage | Expired | | Watchlist | Previous | Recommended |
| | Red | | | | Hit | Scan Alert | not to proceed |
| 21 | ID Invalid | Authentication | Expired | | | | Recommended |
| | Red | Failure | | | | | not to proceed |
| 22 | ID Invalid | Authentication | Expired | | Watchlist | | Recommended |
| | Red | Failure | | | Hit | | not to proceed |
| 23 | ID Invalid | Authentication | Expired | | | Previous | Recommended |
| | Red | Failure | | | | Scan Alert | not to proceed |
| 24 | ID Invalid | Authentication | Expired | | Watchlist | Previous | Recommended |
| | Red | Failure | | | Hit | Scan Alert | not to proceed |
| 25 | ID Invalid | Authentication | Underage | | | | Recommended |
| | Red | Failure | | | | | not to proceed |
| 26 | ID Invalid | Authentication | Underage | | Watchlist | | Recommended |
| | Red | Failure | | | Hit | | not to proceed |
| 27 | ID Invalid | Authentication | Underage | | | Previous | Recommended |
| | Red | Failure | | | | Scan Alert | not to proceed |
| 28 | ID Invalid | Authentication | Underage | | Watchlist | Previous | Recommended |
| | Red | Failure | | | Hit | Scan Alert | not to proceed |
| 29 | ID Invalid | Authentication | Expired | Underage | | | Recommended |
| | Red | Failure | | | | | not to proceed |
| 30 | ID Invalid | Authentication | Expired | Underage | Watchlist | | Recommended |
| | Red | Failure | | | Hit | | not to proceed |
| 31 | ID Invalid | Authentication | Expired | Underage | | Previous | Recommended |
| | Red | Failure | | | | Scan Alert | not to proceed |
| 32 | ID Invalid | Authentication | Expired | Underage | Watchlist | Previous | Recommended |
| | Red | Failure | | | Hit | Scan Alert | not to proceed |
| 33 | Warning | Authentication | | | | | Recommended |
| | Red | Indication | | | | | not to proceed |
| | | Unsupported | | | | | |
| | | document | | | | | |
| | | Card read | | | | | |
| | | error | | | | | |
| | | Authentication | | | | | |
| | | list error | | | | | |
| 34 | Restricted | Restricted ID | | | | | Recommended |
| | ID Red | | | | | | not to proceed |

The primary and secondary indicators may be displayed to the user via one or more of the graphical displays. For example, as illustrated in FIG. 2C, results in the scanned ID pool may include a graphical element 210a, 210b which provides scan results summary which includes an image of the patron (such as from their ID), the patron's name, ID number, and at least the secondary results indicator 212, such as a band, stripe, background or other portion of the summary in the indicator color (such as Green, Red, Yellow, etc.). The use of a secondary visual indicator has substantial advantages: 1) such provides an “at a glance” ability for the user to identify the results and 2) the secondary indicator bolsters or reinforces the primary indicator to ensure that the user doesn't mis-read or mis-interpret the results.

FIG. 2E illustrates a graphical user interface which may be displayed to the user when the ID presented by the patron has been deemed to have “passed.” It will be appreciated that various criteria may be applied for determining whether an ID has passed, such as confirming that the ID is authentic, determining that the person associated with the ID is the patron, determining whether the ID is valid (e.g. not expired), determining whether the patron is of legal age in the particular jurisdiction, etc., such as shown above in relation to Table 1. As indicated in FIG. 2E, these results may include both the primary results indicator (PASSED) 222 and the secondary results indicator 224 (such as green highlighting of displayed elements, a green background color for the “Passed” indicator, etc.). In addition, other features of the graphical interface might include the secondary indicator, such as associated colored bars 210, stripes or other elements thereof.

As illustrated in FIG. 2F, if the ID does not pass, then a fail indication may be provided. Again, such an indication may be provided with both a primary indicator (FAIL/FAILED) 222 and a secondary indicator 224 (e.g., color red). As indicated, information may be displayed regarding which aspects of the authentication analysis passed and/or failed. As illustrated in FIGS. 2G and H, other interfaces might be display in other circumstances, such as if the ID passes certain authentications, but other flags or issues are noted. For example, as part of the authentication process, information about the patron may be passed through one or more databases, such as associated with the processing system 40. Such might comprise an AML system or other system which tracks patrons and patron activities, including flagging patrons who have engaged in suspicious activity. In such a scenario, the ID may be authenticated, but the user of the workstation 26 may be warned about the identified patron, such as that they are on a watchlist of suspicious patrons, etc. In this regard, the scanned ID information (or one or more portions thereof) may be used by or checked against one or more watchlists or databases, including those external to the system (such as government entity watch-lists)—such as directly or via one or more other associated systems or servers, or internal to the user or system (such as the casino). Additional steps or procedures might then be implemented.

In one embodiment, as illustrated in FIG. 21, a user may be permitted to override one or more outcomes or indications associated with the ID authentication process. For example, analysis of scanned ID information may indicate that certain information is missing from the scanned ID information. However, the user may directly view the ID and see that the information is located on the ID, and may thus seek to override failure of the authentication on that basis. As another example, a failure may be indicated because the identified patron is on a watchlist, but after checking with a supervisor, the patron may be cleared. In one embodiment, a log of changes (including changes made, by whom, date and time, etc.) may be maintained for later review.

As illustrated in FIG. 2J, one or more interfaces may be provided which allows a user, such as a user, supervisor, etc. to change one or more settings associated with the process.

As noted above, the authentication process may be performed in association with various transactions, such as when a customer seeks to initiate a monetary value transaction as the casino. Such a transaction might comprise the customer tendering a check to the casino to be cashed for monetary value which the casino might issue as cash (or in other instances, a monetary value ticket, monetary value chips or the like). In such an event, aside from authenticating the ID in the manner described above, additional authorizations or approvals may be required, such as relating to the specific type of transaction. Additional information regarding such a process is described in U.S. Pat. No. 11,093,918, which is also owned by Everi Payments Inc., and which is incorporated herein by reference in its entirety.

In the event such a transaction is approved, then the transaction may be completed. In the example of a patron cashing a check, this may comprise transmitting an approval to the cashier station 26 (such as from the processing system 40). At that point, the cashier station 26 might display information to the cashier, such as that the transaction has been approved and to validate the transaction by confirming the amount of the transaction (such as by double-checking the amount of the check to an amount displayed on the display of the workstation). If the transaction is approved, the server of the processing system 40 may send instructions to the monetary value dispensing mechanism 36 to dispense monetary value. This may comprise, for example, the mechanism 36 dispending currency in the amount of the approved transaction to the cashier. The cashier may then tender those funds to the customer.

As another aspect of the invention, the ID authentication process may run in the background of the cashier workstation 26 or other device, thus enabling the user to perform other tasks while the authentication process is being performed. For example, the cashier workstation 26 may run the CashClub® application and interface by Everi Payments Inc. of Las Vegas, NV. This application interfaces with a back end (such as implemented by the server of the processing system 40) to facilitate monetary transactions, including credit and debit transactions. In such a configuration, as illustrated in FIG. 2K, the user might open the authentication software, scan an ID, select the scanned ID information from the scan pool and send it to authentication, and then minimize the authentication application, such as to use another application—such as CashClub or another application. When the results of the ID authentication are obtained, a notification may be provided to the user. As indicated, such may comprise the display of a pop-up window 230 (which may be implemented as a system tray element) which displays the results (Pass, Fail, etc.) This window, which is preferably small in relation to the total size of the display and other displayed information, is preferably displayed over other application windows 232, thus notifying the user that the authentication results have been obtained and the outcome, while the user is in another application or window. The user can then elect to continue working or could re-enter the authentication application to view additional information, override the results, etc., as described above. This feature might also be applied to user devices which are not implementing the ID authentication process. For example, user devices of floor security personnel might be configured with an application which causes the display of pop-up results to be displayed on a display of their device. This allows, for example, the security personnel to be alerted when an ID of a patron has failed, which might trigger the need for security review or intervention. In such a configuration, these users may be provided with alert type information without the details of information regarding the patron's IDs or details of the ID analysis, thus protecting the privacy of that information while still allowing real-time alerts regarding ID processing to be provided to those users.

As indicated above, features of the invention may be implemented via other devices or integrated with such devices. For example, while in one embodiment, aspects of the invention may be implemented at a cashier workstation, it might be implemented at other workstations, kiosks, terminals and the like. Further, aspects of the invention may also be implemented by a mobile device 56 (see FIG. 1), such as a phone, tablet, laptop or the like, such as via a dedication application running on the device, as webpages via a browser which interfaces with a webserver, etc., such as may communicate with elements of the system 20, such as via a wireless interface 54. For example, the features of the invention might be implemented via a stand-alone device, such as a dedicated device which might be located in a casino or might be located elsewhere, such as at a nightclub or bar (such as might be located at a casino property). Also, the workstation or other device (including mobile devices) might be linked to a variety of other devices, such as essentially comprise a backend hub gateway to other products or systems, such as a variety of casino-related systems (check-cashing, check warranty, wallet, central credit, compliance, loyalty, etc.).

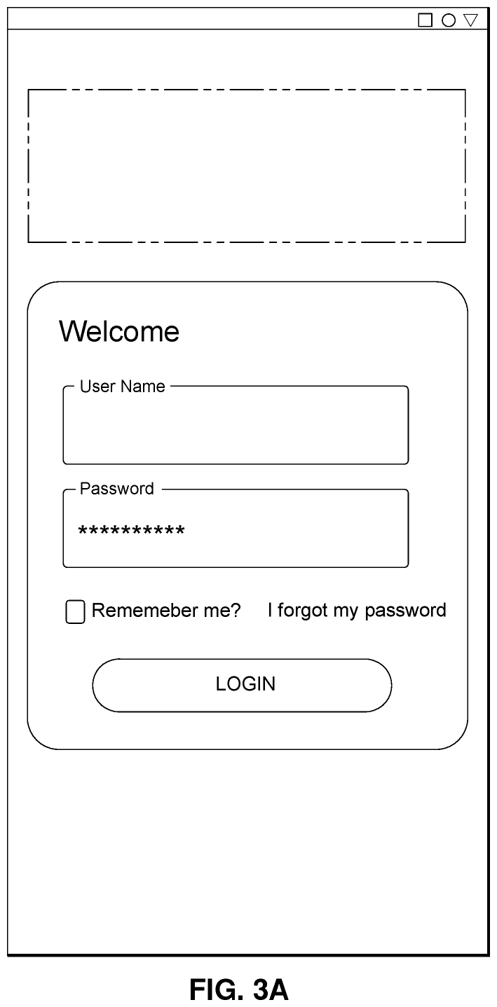

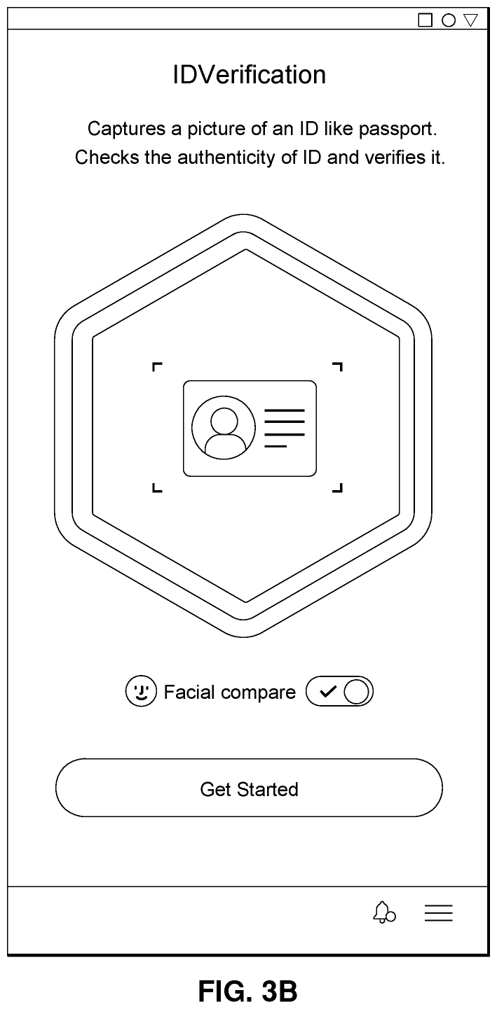

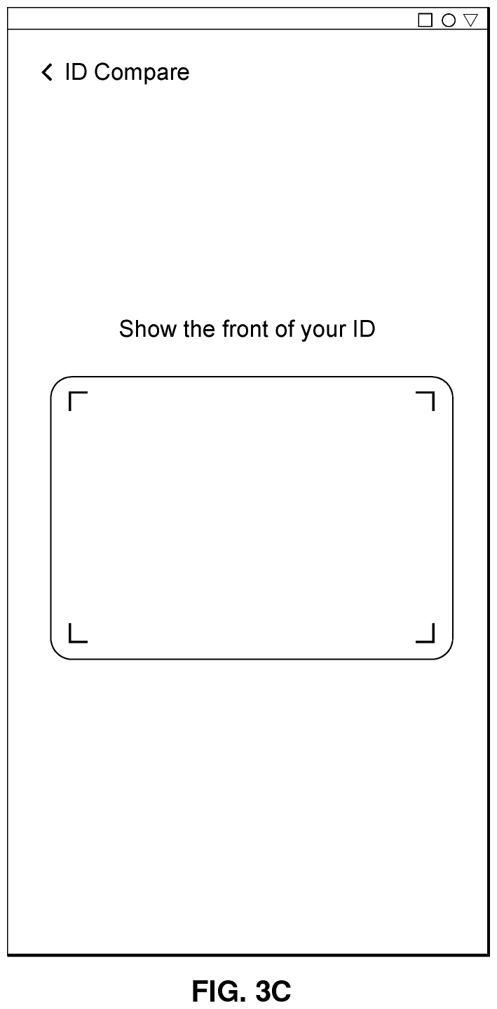

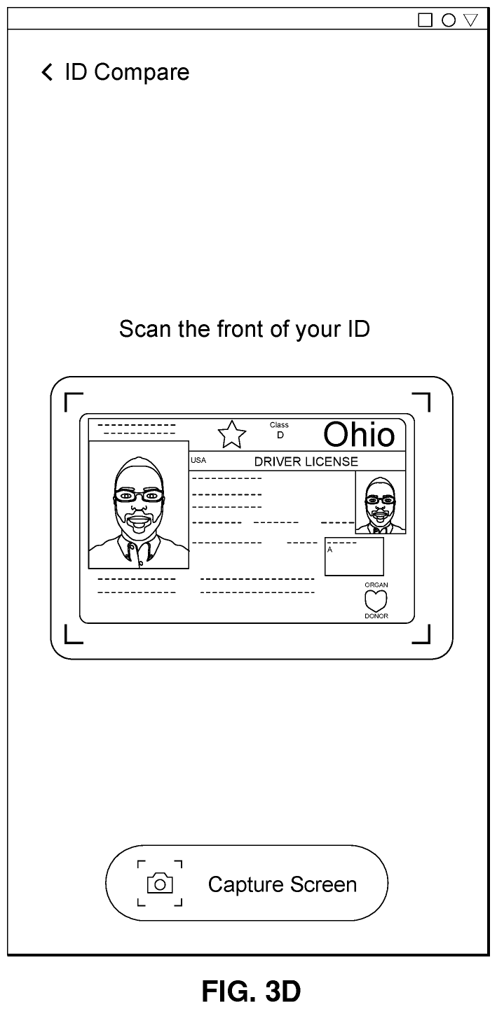

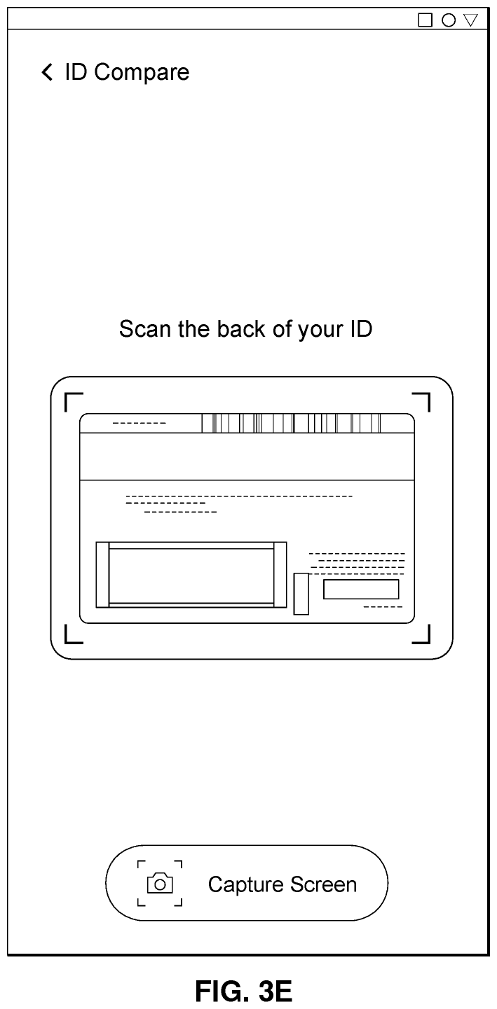

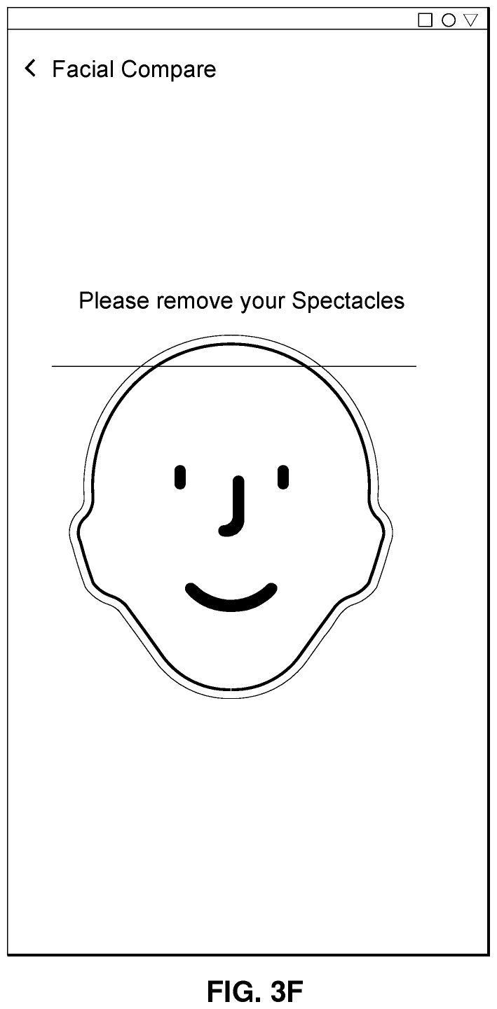

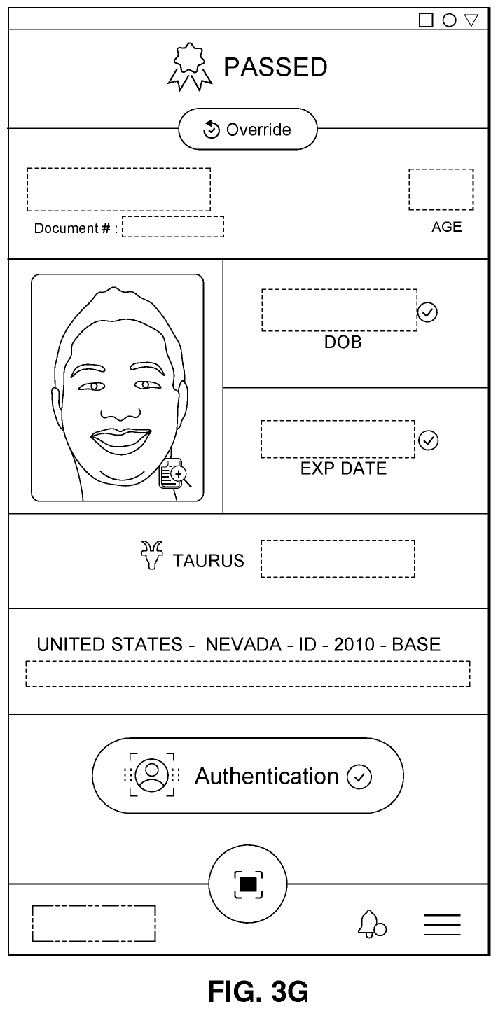

FIGS. 3A-K illustrate graphical interfaces that may be displayed by a mobile device of a user. Once again, as illustrated in FIG. 3A, the application may require that a user login to use the application, such as by providing a user name and password. Once logged in, a user may have the option to authenticate a patron's ID, such as relative to a casino transaction (for example, a casino attendant might travel to a gaming machine to verify and pay a jackpot to a patron, where the attendant uses a mobile device to authenticate the patron's ID as part of that process). As illustrated in FIG. 3B, the user may be instructed to scan the patron's ID. Further, the user may have the option to require a facial comparison, described in more detail below).

In this example, instead of capturing ID information via a shared scanner, information regarding the ID may be captured by an image capture device associated with the mobile device. Such might comprise, for example, a camera or other image capture device thereof. As illustrated in FIGS. 3C, 3D and 3E, interfaces may be displayed regarding the capture of images of the front and back of the patron's ID. In one embodiment, the scanned ID information is again used to authenticate the ID, such as in the manner described above (such as where the scanned ID information is transmitted for authentication, such as to a remote vendor).

In one embodiment, the user might elect, or be required, to obtain an image of the patron (such as their face), such as illustrated in FIG. 3F. In one embodiment, the captured image may be compared to the image or photo which is associated with the patron's ID to verify that they are the same.

Once the results of the authentication (and any photo verification, if required) are complete, they may be displayed to the user of the mobile device, such as illustrated in FIG. 3G. Once again, a variety of information may be displayed, such as whether the authentication and any photo verification pass, failed, the basis for any failure, etc., in a similar manner to that described above.

It will be appreciated that principles of the invention may be applied to physical IDs, such as printed drivers licenses and passports, but also digital IDs. For example, in some embodiments, a mobile device may be configured to receive or read information from or regarding a digital ID, and utilize that information in the authentication process.

As indicated herein, the invention may include other features. For example, in some cases, the ID authentication process might require secondary validation or other steps. As one example, if the authentication process results in a failure, warning or the like, one or more secondary validations might be performed. For example, upon an ID authentication failure, the patron might be instructed to travel to a supervisor and have secondary patron identification performed, such as using information other than the patron's ID.

The system may implement an administration feature, such as to permit an administrator (with admin level access/ID) to customize or modify certain features, to implement audit or other admin level features.

The system and method may support both manual and automated image capture functionality (e.g. such as manual and automated image capture focus input as part of capturing an image of an ID).

In one embodiment, while the scanned ID information may be retrieved from the scan pool and then deleted from the scan pool, or deleted if not retrieved in a designated period of time, the scanned ID information may still be maintained elsewhere, such as in a secure memory (such as a secure storage associated with the processing system 40 or a related system. In such a configuration, the scanned ID information is removed or deleted from the scan pool and can no longer be accessed therefrom, such as by the users of the workstations 26. However, the scanned ID information may be maintained in another location, such as in a secure memory, such as for use by other applications or systems.

It will be appreciated that features of the invention may be utilized independently of one another, with other features or in other combinations; for example, aspects of the invention relating to the presentation of ID scans and scan results might be used independently of other features of the invention, including in other applications.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of casino patron ID authentication comprising the steps of:
scanning a patron ID provided by a patron via an ID reader;
transmitting, from a cashier workstation comprising a processor, a memory, at least one user input device, a display, a communication interface and machine-readable code stored in said memory and executable by said processor, said scanned ID information to a remote device for use in authenticating said patron ID;
displaying, via said display of said cashier workstation a graphical user interface which indicates a result of said authentication of said patron ID, said graphical user interface comprising at least a first primary results indicator and a second results indicator.

2. The method in accordance with claim 1, wherein said first primary results indicator comprises a textual indicator and said second results indicator comprises a non-textual indicator.

3. The method in accordance with claim 2, wherein said non-textual indicator comprises a color.

4. The method in accordance with claim 3, wherein said color is applied to at least one background portion of at least one element of said graphical user interface.

5. The method in accordance with claim 1, wherein said ID reader comprises one or more of a white light, IR and UV optical scanner.

6. The method in accordance with claim 1, wherein said scanned ID information is transmitted to remote authentication vendor.

7. A system for casino patron ID authentication comprising:
a processor server comprising a processor, a memory and machine-readable code stored in said memory and executable by said processor;
a cashier workstation comprising a processor, a memory, at least one user input device, a display, a communication interface and machine-readable code stored in said memory and executable by said processor, said cashier workstation communicatively linked to said processor server;
an ID reader, said ID reader communicatively linked to said processor server;
said ID reader configured to scan a patron ID provided by a patron via an ID reader;
said processor server configured to transmit the scanned patron ID information to a remote device for use in authenticating said patron ID; and
said processor server configured to cause said cashier workstation to display, via said display thereof, a graphical user interface which indicates a result of said authentication of said patron ID, said graphical user interface comprising at least a first primary results indicator and a second results indicator.

8. The system in accordance with claim 7, wherein said first primary results indicator comprises a textual indicator and said second results indicator comprises a non-textual indicator.

9. The system in accordance with claim 8, wherein said non-textual indicator comprises a color.

10. The system in accordance with claim 9, wherein said color is applied to at least one background portion of at least one element of said graphical user interface.

11. The system in accordance with claim 7, wherein said ID reader comprises one or more of a white light, IR and UV optical scanner.

12. The system in accordance with claim 7, wherein said scanned ID information is transmitted to remote authentication vendor.

13. The system in accordance with claim 8, wherein said textual indicator comprises at least one of pass or fail.
